(19) United States
(12) Patent Application Publication
(10) Pub. No.: US 2022/0019211 A1
(43) Pub. Date: Jan. 20, 2022

(54) METHOD AND SYSTEM FOR PREDICTING A MAINTENANCE PERIOD OF EQUIPMENT USED IN A FACILITY

(71) Applicant: Facilio Inc., Lewes, DE (US)

(72) Inventors: Prabhu RAMACHANDRAN, Chennai (IN); Yogendrababu VENKATAPATHY, Chennai (IN); Rajavel SUBRAMANIAN, Chennai (IN); Shivaraj SELVANATHAN, Chennai (IN)

(73) Assignee: Facilio Inc., Lewes, DE (US)

(21) Appl. No.: 16/932,648

(22) Filed: Jul. 17, 2020

(51) Int. Cl. G05B 23/02

(52) U.S. Cl. CPC G05B 23/0283; G05B 23/027; G05B 23/0272

(57) ABSTRACT

The present disclosure provides a method and system for predicting a maintenance time of a plurality of equipment used in a facility. A facility management system receives a sensor data from one or more sensors. A cloud platform collects the sensor data. In addition, a defect diagnostic engine analysis the sensor data for detection of one or more defects in the one or more sensors and the plurality of equipment. Further, the defect diagnostic engine detects the one or more defects in the one or more sensors and the plurality of equipment. Furthermore, the defect diagnostic engine creates a planned maintenance chart. Moreover, the defect diagnostic engine sends the planned maintenance chart to a user in real time.

### TECHNICAL FIELD

The present disclosure relates to the field of facility management and, in particular, relates to a method and system for predicting maintenance period of equipment used in a facility.

### INTRODUCTION

With the advent in technological advancements over the past few decades, there has been an exponential rise in the number of large facilities. These facilities are big residential complexes, commercial offices, shopping centers and the like. Nowadays, it is a very common to see facilities with multiple equipment. These equipments are located inside a home, an office or any other facility associated with a user. In addition, these equipments are frequently utilized by the user for carrying out various tasks. Examples of these equipments include air handling unit, de-humidifiers, escalators, heating unit, ventilation unit, air conditioning unit, transformer, electricity meter, air conditioning system, fire detection system, elevator system, lightening system, and the like. Further, a majority of the equipments require regular monitoring, maintenance and servicing for ensuring efficient and long term working of the equipments. Currently, there are various facility management systems available in the market which allows the users to control and monitor the working of the equipments inside the facility in real time.

### SUMMARY

In a first example, a computer-implemented method is provided. The computer-implemented method for predicting maintenance time of a plurality of equipment used in a facility. The computer-implemented method includes a first step to receive a sensor data from one or more sensors. The computer-implemented method includes a second step to collect the sensor data. In addition, the computer-implemented method includes a third step to analyse the sensor data for detection of one or more defects in the one or more sensors installed at the plurality of equipment by using machine learning algorithms. The sensor data is analysed in real time. Further, the computer-implemented method includes a fourth step to detect the one or more defects in the one or more sensors and the plurality of equipment installed at various locations in the facility based on the analysis of the sensor data. The defect is detected in real time. Furthermore, the computer-implemented method includes a fifth step to create a planned maintenance chart. Moreover, the computer-implemented method includes a sixth step to send the planned maintenance chart to a user with facilitation of a plurality of media devices. In addition, the planned maintenance chart is sent to the user in real time. Further, the one or more sensors are installed at the plurality of equipment. The plurality of equipment is installed at various locations in the facility. The sensor data is received in real time. Furthermore, the cloud platform is associated with a server. Moreover, the planned maintenance chart is based on the detection of the one or more defects and the analysis of the sensor data by using machine learning algorithms. Also, the computer-implemented method includes a financial analyser and a longevity estimator, a probability of failure predictor, or both.

In an embodiment of the present disclosure, the one or more sensors include a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

In an embodiment of the present disclosure, the plurality of equipment includes distribution board, transformer, electricity meter, escalators, heating unit, ventilation unit, boiler unit, direct generation system, transmission system, air conditioning unit, fire detection system, circuit breaker, elevators, electricity meter, circuit disconnects, junction boxes, and electric switchgear.

In an embodiment of the present disclosure, the sensor data includes device temperature, facility temperature, usage time of device, device behavior, device output, device efficiency, device anomaly history, lighting settings, air pressure data, humidity, and air quality index.

In an embodiment of the present disclosure, the plurality of media devices include a computer, laptop, smart television, PDA, electronic tablet, smartphone, wearable devices, tablet, smartwatch, smart display, and gesture-controlled devices.

In an embodiment of the present disclosure, the computer-implemented method includes a step to obtain a planned maintenance chart. In addition, obtaining the planned maintenance chart is done in real time.

In an embodiment of the present disclosure, the computer-implemented method includes another step to send a maintenance alert to the user on the plurality of media devices. In addition, the maintenance alert is based on the planned maintenance chart for each of the one or more sensors receiving faults on a periodic basis.

In an embodiment of the present disclosure, the one or more faults include short circuit fault, device failure, symmetrical fault, unsymmetrical fault, temperature fault, efficiency fault, device noise fault, circuit overload, and lighting fault.

In an embodiment of the present disclosure, the computer-implemented method identifies facility location, fault location, anomaly type, mean time to repair, required device and required skills, wherein identification is done in real time.

In an embodiment of the present disclosure, the machine learning algorithms include decision tree machine learning algorithm, random forest machine learning algorithm, naive bayes classifier machine learning algorithm, support vector machine learning algorithm, k-nearest neighbors machine learning algorithm, and linear regression machine learning algorithm.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for predicting maintenance time of a plurality of equipment used in a facility. The method includes a first step to receive a sensor data from one or more sensors. The method includes a second step to collect the sensor data. In addition, the method includes a third step to analyse the sensor data for detection of one or more defects in the one or more sensors installed at the plurality of equipment by using machine learning algorithms. The sensor data is analysed in real time. Further, the method includes a fourth step to detect the one or more defects in the one or more sensors and the plurality of equipment installed at various locations in the facility based on the analysis of the sensor data. The defect is detected in real time. Furthermore, the method includes a fifth step to create a planned maintenance chart. Moreover, the method includes a sixth step to send the planned maintenance chart to a user with facilitation of a plurality of media devices. In addition, the planned maintenance chart is sent to the user in real time. Further, the one or more sensors are installed at the plurality of equipment. The plurality of equipment is installed at various locations in the facility. The sensor data is received in real time. Furthermore, the cloud platform is associated with a server. Moreover, the planned maintenance chart is based on the detection of the one or more defects and the analysis of the sensor data by using machine learning algorithms. Also, the method includes a financial analyser and a longevity estimator, a probability of failure predictor, or both.

In a third example, a non-transitory computer-readable storage medium is provided. The non-transitory computer-readable storage medium encodes computer executable instructions. The computer executable instructions are executed by at least one processor to perform a method for predicting maintenance time of a plurality of equipment used in a facility. The method includes a first step to receive a sensor data from one or more sensors. The method includes a second step to collect the sensor data. In addition, the method includes a third step to analyse the sensor data for detection of one or more defects in the one or more sensors installed at the plurality of equipment by using machine learning algorithms. The sensor data is analysed in real time. Further, the method includes a fourth step to detect the one or more defects in the one or more sensors and the plurality of equipment installed at various locations in the facility based on the analysis of the sensor data. The defect is detected in real time. Furthermore, the method includes a fifth step to create a planned maintenance chart. Moreover, the method includes a sixth step to send the planned maintenance chart to a user with facilitation of a plurality of media devices. In addition, the planned maintenance chart is sent to the user in real time. Further, the one or more sensors are installed at the plurality of equipment. The plurality of equipment is installed at various locations in the facility. The sensor data is received in real time. Furthermore, the cloud platform is associated with a server. Moreover, the planned maintenance chart is based on the detection of the one or more defects and the analysis of the sensor data by using machine learning algorithms. Also, the method includes a financial analyser and a longevity estimator, a probability of failure predictor, or both.

### BRIEF DESCRIPTION OF THE FIGURES

Having thus described the invention in general terms, references will now be made to the accompanying figures, wherein:

FIG. 1 illustrates an interactive computing environment for predicting a maintenance period of equipment used in a facility in real time, in accordance with various embodiments of the present disclosure;

FIGS. 2A and 2B illustrate a flowchart of the method for predicting the maintenance period of equipment used in the facility in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

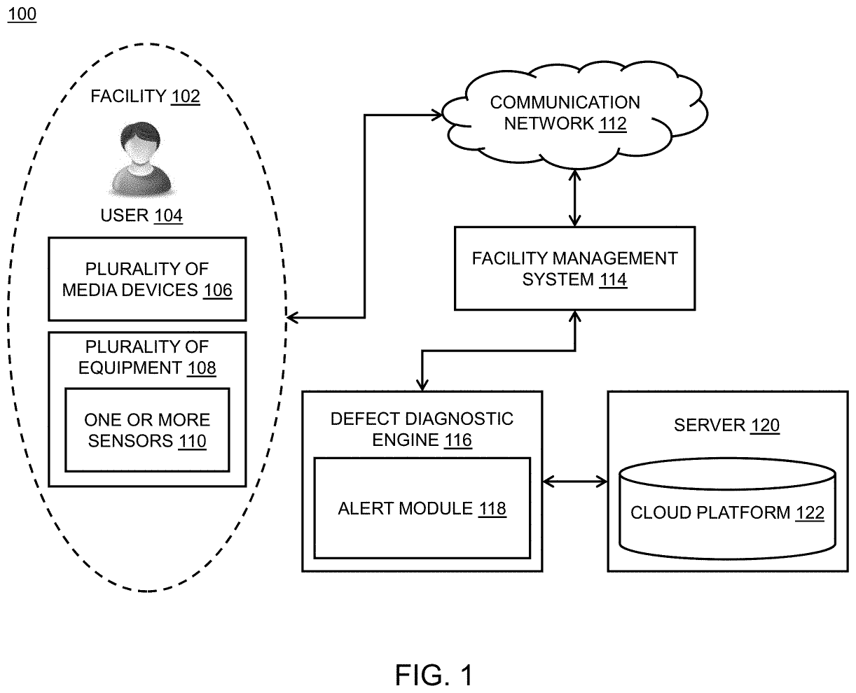

FIG. 1 illustrates an interactive computing environment 100 for predicting a maintenance period of equipment used in a facility 102 in real time, in accordance with various embodiments of the present disclosure. The interactive computing environment 100 shows a relationship between various entities involved in the detection of one or more defects in a plurality of equipment 108 and in one or more sensors 110 installed in the facility 102. In addition, the interactive computing environment 100 shows a relationship between various entities involved in the generation of a planned maintenance chart for a maintenance schedule of the plurality of equipment 108 and in the one or more sensors 110 installed in the facility 102.

The interactive computing environment 100 includes the facility 102, a user 104, a plurality of media devices 106, the plurality of equipment 108, and one or more sensors 110. In addition, the interactive computing environment 100 includes a communication network 112, a facility management system 114, a defect diagnostic engine 116 and an alert module 118. Moreover, the interactive computing environment 100 includes a server 120 and a cloud platform 122. The above-stated elements of the interactive computing environment 100 operate coherently and synchronously.

The interactive computing environment 100 includes the facility 102. In general, facility referred to as a building, property, residence or event space that is provided for any occasion, event or for personal use. In an embodiment of the present disclosure, the facility 102 is any building where people come for events. In another embodiment of the present disclosure, the facility 102 is any place where equipment is installed and working simultaneously to make the place comfortable for guests. In yet another embodiment of the present disclosure, the facility 102 is any place where the facility management system 114 is installed. In yet another embodiment of the present disclosure, the facility 102 is any place where the defect diagnostic engine 116 is installed. In an example, the facility 102 is the place for various events like reception party, anniversary party, trade events, and the like.

The interactive computing environment 100 is associated with the user 104. In an embodiment of the present disclosure, the user 104 is present inside the facility 102. In another embodiment of the present disclosure, the user 104 includes one or more human machinists, one or more employee, visitors, a plurality of occupants, one or more data managers, and the like. In an example, the one or more employee monitors and controls the facility management system 114. In another example, the one or more employee clean, sweep and repair the plurality of equipment 108 and the one or more sensors 110. In yet another example, the plurality of occupants includes managers, attendants, assistants, clerk, security staff and the like. In yet another example, the visitors are civilians present for a specific period of time. In yet another embodiment of the present disclosure, the user 104 is any person who wants to view or manage the plurality of equipment 108 and the one or more sensors 110. In another embodiment of the present disclosure, the user 104 is any person who has the authority to manage the plurality of equipment 108 and the one or more sensors 110. In yet another embodiment of the present disclosure, the user 104 is any person from a facility management team.

In addition, the facility management team includes one or more persons assigned for servicing and maintaining the plurality of equipment 108 and the one or more sensors 110 installed in the facility 102. In yet another embodiment of the present disclosure, the user 104 is any person who wants to know the status of the one or more defects detected by the defect diagnostic engine 116. In yet another embodiment of the present disclosure, the user 104 is any person who is managing an event in the facility 102. In yet embodiment of the present disclosure, the user 104 is any person who has the knowledge to operate the defect diagnostic engine 116. In yet embodiment of the present disclosure, the user 104 is any person who operates the defect diagnostic engine 116. In yet embodiment of the present disclosure, the user 104 is any person who operates the alert module 118. In yet another embodiment of the present disclosure, the user 104 may be any person. The user 104 may interact with the defect diagnostic engine 116 and with the alert module 118 directly through the plurality of media devices 106. In some cases, the user 104 may interact with the defect diagnostic engine 116 via the plurality of media devices 106 through the communication network 112.

Further, communication network denotes to channels of communication (networks by which information flows). Small networks, which are used for connection to the subgroup and are usually contained in a piece of equipment. The local area network, or LAN, cable or fiber, is used to connect computer equipment and other terminals distributed in the local area, such as in the college campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In yet another embodiment of the present disclosure, the communication network 112 may be any type of network that provides internet connectivity to the facility management system 114. In yet another embodiment of the present disclosure, the communication network 112 may be any type of network that provides internet connectivity to the defect diagnostic engine 116. In yet embodiment of the present disclosure, the communication network 112 is a wireless mobile network. In yet embodiment of the present disclosure, the communication network 112 is a wired network with finite bandwidth. In yet another embodiment of the present disclosure, the communication network 112 is a combination of the wireless and the wired network for optimum throughput of data transmission. In yet another embodiment of the present disclosure, the communication network 112 is an optical fiber high bandwidth network that enables high data rate with negligible connection drops. In yet another embodiment of the present disclosure, the communication network 112 provides medium for the plurality of media devices 106 to connect to the facility management system 114 and the defect diagnostic engine 116. In this scenario, the communication network 112 may be a global network of computing devices such as the Internet.

The interactive computing environment 100 includes the plurality of media devices 106. Commonly, media device refers to equipment or device capable of transmitting analog or digital signals through communication wire or remote way. The best case of the media device is a PC modem, which is equipped for sending and getting analog or digital signals to enable PCs to converse with different PCs. In an embodiment of the present disclosure, the plurality of media devices 106 includes but may not be limited to a computer, laptop, smart television, PDA, electronic tablet, smartphone, wearable devices, tablet, smartwatch, smart display, gesture-controlled devices, and the like. In an example, the plurality of media devices 106 displays, reads, transmits and gives output to the user 104 in real time. In another example, the plurality of media devices 106 reads or scans user-defined rules and user inputs in real time.

In an embodiment of the present disclosure, each of the plurality of media devices 106 are a portable device with an inbuilt application program interface (hereafter “API”). The inbuilt API of each of the plurality of media devices 106 are associated with a camera, a global positioning system, keypad, and the like. In addition, the keypad gathers manual data input from the user 104. In another embodiment of the present disclosure, the plurality of media devices 106 is connected to the facility management system 114 with the facilitation of the plurality of media devices 106. In another embodiment of the present disclosure, the plurality of media devices 106 is connected to the defect diagnostic engine 116 with the facilitation of the communication network 112.

The interactive computing environment 100 includes the plurality of equipment 108. The plurality of equipment 108 is associated with a plurality of mechanical equipment, a plurality of electrical equipment, and a plurality of electronic equipment. In addition, the plurality of equipment 108 may be related or unrelated to structure and the operations of the facility 102. Further, the plurality of mechanical equipment includes air handling unit, de-humidifiers, escalators, elevators, heating unit, ventilation unit, air conditioning unit, boiler unit, and the like. Furthermore, the plurality of electrical equipment includes direct generation system, distribution board, transformer, transmission system, junction boxes, electric switchgear, circuit breaker, electrical wiring, and the like. Moreover, the plurality of electronic equipment includes but may not be limited to fire detection system, electricity meter, circuit disconnects, lighting system, electronic lock system, and intercom system.

The interactive computing environment 100 includes the one or more sensors 110. Generally, sensors are referred to as a device that detects and measures the conversion of energy based on physical parameters or processes and converts real-world information into electrical signals. The sensors are usually used to recognize or perceive some of the features of an environment. In an embodiment of the present disclosure, the one or more sensors 110 are smart sensors installed at various locations on the facility 102. In another embodiment of the present disclosure, the one or more sensors 110 are installed in the plurality of equipment 108. The one or more sensors 110 includes a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, biometric sensors, and the like. In an example, the one or more sensors 110 are installed in various rooms in a building, corridors in the building, and the like. In yet another embodiment of the present disclosure, the one or more sensors 110 are IOT based connected sensors. In yet another embodiment of the present disclosure, the one or more sensors 110 provides ambient parameters. The one or more sensors 110 includes temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, biometric sensors, and the like.

The interactive computing environment 100 includes the facility management system 114. In an embodiment of the present disclosure, the facility management system 114 manages, monitors, and controls various functionality of the plurality of equipment 108 installed in the facility 102. In another embodiment of the present disclosure, the facility management system 114 facilitates the user 104 to monitor and control various functionality of the plurality of equipment 108 installed in the facility 102 in real time. In addition, the facility management system 114 is accessed through a web browser. In yet another embodiment of the present disclosure, the facility management system 114 is accessed through a widget, API, web applets and the like. In an example, the web-browser includes but may not be limited to Opera, Mozilla Firefox, Google Chrome, Internet Explorer, Microsoft Edge, Safari and UC Browser. Further, the web browser runs on any version of the respective web browser of the above-mentioned web browsers.

In addition, the facility management system 114 performs computing operations based on a suitable operating system installed inside the facility management system 114. In general, the operating system is system software that manages computer hardware and software resources and provides common services for computer programs. In addition, the operating system acts as an interface for software installed inside the facility management system 114 to interact with hardware components of the facility management system 114. In an embodiment of the present disclosure, the operating system installed inside the facility management system 114 is a mobile operating system. In an embodiment of the present disclosure, the facility management system 114 performs computing operations based on any suitable operating system designed for portable the facility management system 114. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the facility management system 114 operates on any version of a particular operating system of above-mentioned operating systems.

In another embodiment of the present disclosure, the facility management system 114 performs computing operations based on any suitable operating system designed for controlling and managing the plurality of equipment 108 and the one or more sensors 110. In an example, the operating system installed inside the facility management system 114 is Windows from Microsoft. In another example, the operating system installed inside the facility management system 114 is Mac from Apple. In yet another example, the operating system installed inside the facility management system 114 is a Linux based operating system. In yet another example, the operating system installed inside the facility management system 114 may be one of UNIX, Kali Linux, and the like. However, the operating system is not limited to above mentioned operating systems.

In yet another embodiment of the present disclosure, the facility management system 114 operates on any version of Windows operating system. In another embodiment of the present disclosure, the facility management system 114 operates on any version of Mac operating system. In another embodiment of the present disclosure, the facility management system 114 operates on any version of the Linux operating system. In yet another embodiment of the present disclosure, the facility management system 114 operates on any version of a particular operating system of the above-mentioned operating systems.

In addition, the facility management system 114 receives the information from the plurality of equipment 108 and the one or more sensors 110. Further, the received information from the plurality of equipment 108 and the one or more sensors 110 are termed as sensor data. For example, data received form lighting system, fire alarm system, heating ventilation and air conditioning, and the like. Generally, sensor data is referred to as the output of a device that detects a particular kind of input from the physical environment and responds. Output can be used to provide information or input to any other system or to direct a process. In an embodiment of the present disclosure, the sensor data include but may not limit to device temperature, facility temperature, usage time of device, device behaviour, device output, device efficiency, device anomaly history, lighting settings, air pressure data, humidity, and air quality index. In addition, the collection of the sensor data uses a method. In another embodiment of the present disclosure, the method involves the digital collection of data for each of the plurality of equipment 108. Further, the sensor data is transferred to the facility management system 114.

The interactive computing environment 100 includes the defect diagnostic engine 116. The defect diagnostic engine 116 performs various computing actions on the sensor data. In an embodiment of the present disclosure, the defect diagnostic engine 116 detects the one or more defects in the plurality of equipment 108 and in the one or more sensors 110 installed in the facility 102. The defect diagnostic engine 116 includes a financial analyser and a longevity estimator, a probability of failure predictor, or both. Further, the interactive computing environment 100 includes the alert module 118. The alert module 118 is associated with the defect diagnostic engine 116. In another embodiment of the present disclosure, the alert module 118 creates a maintenance alert for the maintenance of the plurality of equipment 108. In yet another embodiment of the present disclosure, the alert module 118 sends the maintenance alert to the user 104 in real time.

Further, the interactive computing environment 100 includes the server 120. In an embodiment of the present disclosure, the facility management system 114 is associated with the server 120. In another embodiment of the present disclosure, the defect diagnostic engine 116 is associated with the server 120. In yet another embodiment of the present disclosure, the facility management system 114 is installed at the server 120. In yet another embodiment of the present disclosure, the facility management system 114 is installed at a plurality of servers. In general, a server refers to a computer that provides data to other computers. It may serve data to systems on a local area network (LAN) or a wide area network (WAN) over the Internet. Many types of servers exist, including web servers, mail servers, file servers, and the like. Each type of server runs software specific to the purpose of the server. For example, a Web server may run Apache HTTP Server or Microsoft IIS, which both provide access to websites over the Internet. A mail server may run a program like Exim or I Mail, which provides SMTP services for sending and receiving the email. A file server might use Samba or the operating system's built-in file sharing services to share files over a network. While server software is specific to the type of server, the hardware is not as important. In fact, a regular desktop computer can be turned into a server by adding the appropriate software. For example, a computer connected to a home network can be designated as a file server, print server, or both. In another example, the plurality of servers may include a database server, file server, application server and the like. The plurality of servers communicates with each other using the communication network 112.

In an embodiment of the present disclosure, the facility management system 114 is located in the server 120. In yet another embodiment of the present disclosure, the facility management system 114 is connected with the server 120. In yet another embodiment of the present disclosure, the server 120 is a part of the facility management system 114. In an embodiment of the present disclosure, the server 120 receives data from the cloud platform 122.

The interactive computing environment 100 includes the cloud platform 122. Generally, a cloud platform refers to a data structure that stores organized information. Most cloud platforms contain multiple tables, which may each include several different fields. For example, a hotel cloud platform may include records related to rooms available, invoice records, food menu, staff record, and guest details. Each of these tables would have different fields that are relevant to the information stored in the table. In addition, the cloud platform 122 stores the sensor data in real time. In an embodiment of the present disclosure, the sensor data stored on the cloud platform 122 can be used for future analysis of the sensor data. In another embodiment of the present disclosure, the sensor data stored on the cloud platform 122 can be used for predicting maintenance for the plurality of equipment 108 and the one or more sensors 110 before the one or more defects arise.

In an embodiment of the present disclosure, the facility management system 114 receives the sensor data from the one or more sensors 110. The one or more sensors 110 are installed at the plurality of equipment 108. In another embodiment of the present disclosure, the plurality of equipment 108 is installed at various locations in the facility 102. In addition, the sensor data is received in real time. Further, the sensor data is collected on the cloud platform 122. The sensor data is collected in real time.

In an embodiment of the present disclosure, the defect diagnostic engine 116 analyses the sensor data for detection of the one or more defects in the one or sensors 110 installed at the plurality of equipment 118 by using machine learning algorithms. The machine learning algorithms include decision tree machine learning algorithm, random forest machine learning algorithm, naive bayes classifier machine learning algorithm, support vector machine learning algorithm, k-nearest neighbors machine learning algorithm, linear regression machine learning algorithm, and the like. In addition, the sensor data is analysed in real time. Further, the defect diagnostic engine 116 detects the one or more defects in the one or more sensors 110 and the plurality of equipment 108 installed at various locations in the facility 102 based on the analysis of the sensor data. Also, the one or more defects are detected in real time. The one or more faults include short circuit fault, device failure, symmetrical fault, unsymmetrical fault, temperature fault, efficiency fault, device noise fault, circuit overload, lighting fault, and the like. Simultaneously, the defect diagnostic engine 116 identifies facility location, fault location, anomaly type, mean time to repair, required device, required skills, and the like.

Further, the defect diagnostic engine 116 creates the planned maintenance chart. The planned maintenance chart is based on detection of the one or more defects and the analysis of the sensor data by using machine learning algorithms. In an embodiment of the present disclosure, the defect diagnostic engine 116 predicts cost of repair, life estimation of the plurality of equipment 108 and the one or more sensors 110. In another embodiment of the present disclosure, the defect diagnostic engine 116 predicts a probability of failure of the plurality of equipment 108 and the one or more sensors 110. Furthermore, the defect diagnostic engine 116 sends the planned maintenance chart to the user 104 with the facilitation of the plurality of media devices 106. The planned maintenance chart is sent to the user 104 in real time. The planned maintenance chart corresponds to a plurality of information associated with the plurality of equipment 108 and the one or more sensors 110. The plurality of information includes frequency tables, pie charts, line graphs, stem and leaf diagram, bar graphs, cost of repair, p-f curve, plotting scatter diagram, the average life of sensors and equipment, frequent faults in sensors or equipment, and the like. In an example, the planned maintenance chart may include information about the average lifetime of the one or more sensors 110. The planned maintenance chart advice the user 104 to replace or repair the one or more sensors 110 on time before it creates a big defect. In another example, the planned maintenance chart advice a user X to clean air filters of the HVAC system on a definite intermittent period. In an embodiment of the present disclosure, the alert module 118 obtains the maintenance chart from the defect diagnostic engine 116. Further, the alert module 118 generates the maintenance alert and sends it to the user 104 on the plurality of media devices 106. The maintenance alert is based on the planned maintenance chart for each of the one or more sensors 110 receiving faults on a periodic basis.

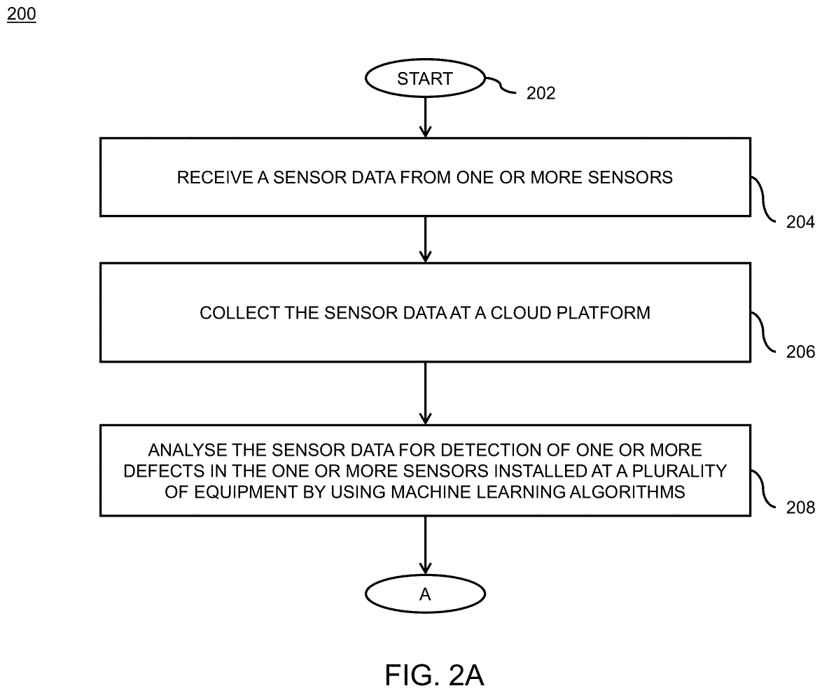

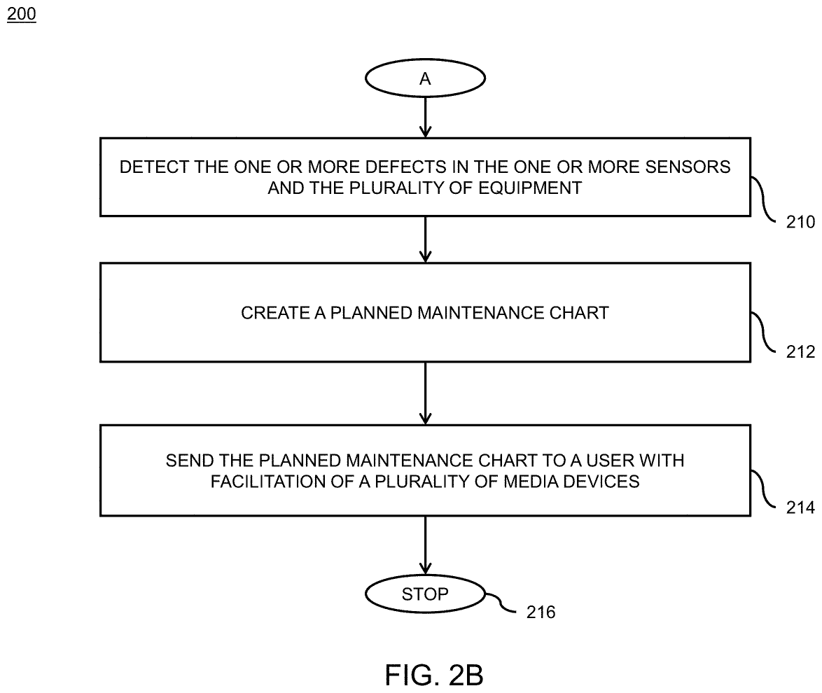

FIGS. 2A and 2B illustrate a flowchart 200 of the method for predicting the maintenance period of equipment used in the facility 102 in real time, in accordance with various embodiments of the present disclosure. It may be noted that in order to explain the method steps of the flowchart 200, references will be made to the elements explained in FIG. 1. The flowchart 200 starts at step 202. At step 204, the facility management system 114 receives the sensor data from the one or more sensors 110. At step 206, the cloud platform 122 associated with the facility management system 114 collects the sensor data. At step 208, the defect diagnostic engine 116 analyses the sensor data for detection of the one or more defects in the one or more sensors 110 installed at the plurality of equipment 108. At step 210, the defect diagnostic engine 116 detects the one or more defects in the one or more sensors 110 and the plurality of equipment 108. At step 212, the defect diagnostic engine 116 creates the planned maintenance chart. At step 214, the defect diagnostic engine 116 sends the planned maintenance chart to the user 104 with facilitation of the plurality of media devices 106. The flow chart 200 terminates at step 216.

It may be noted that the flowchart 200 is explained to have above stated process steps; however, those skilled in the art would appreciate that the flowchart 200 may have more/less number of process steps which may enable all the above stated embodiments of the present disclosure.

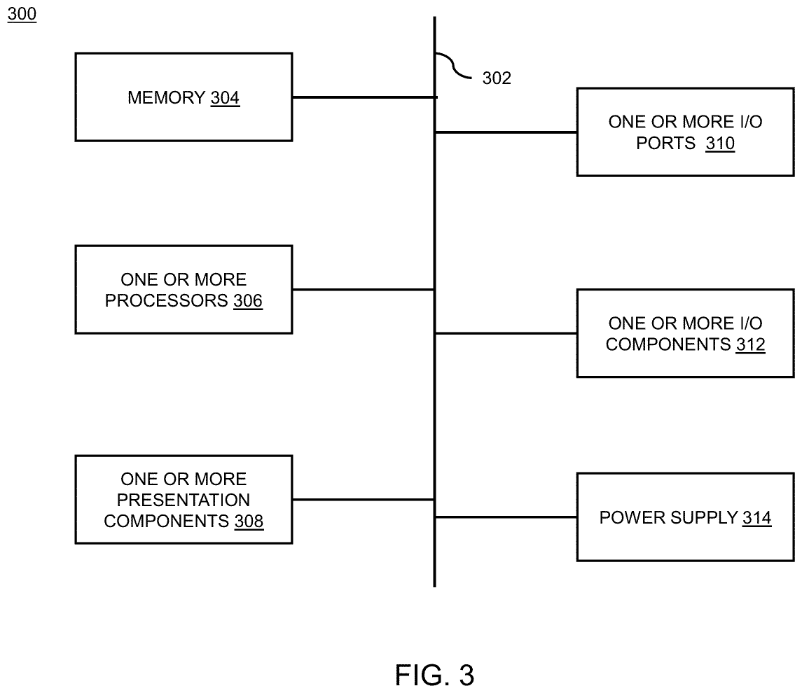

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and non-volatile media, removable and non-removable media. By way of example, and not limitation, the computer-readable media may comprise computer storage media and communication media. The computer storage media includes volatile and non-volatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300.

In addition, the communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or non-volatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to the user 104 or another device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for predicting a maintenance time of a plurality of equipment used in a facility, the computer-implemented method comprising:
receiving, at a facility management system with a processor, a sensor data from one or more sensors, wherein the one or more sensors is installed at the plurality of equipment, wherein the plurality of equipment is installed at various locations in the facility, wherein the sensor data is received in real time;
collecting, at a cloud platform associated with the facility management system with the processor, the sensor data, wherein the cloud platform is associated with a server, wherein the sensor data is collected in real time;
analysing, at a defect diagnostic engine associated with the facility management system with the processor, the sensor data for detection of one or more defects in the one or more sensors installed at the plurality of equipment by using machine learning algorithms, wherein the sensor data is analysed in real time;
detecting, at the defect diagnostic engine, the one or more defects in the one or more sensors and at least one equipment of the plurality of equipment installed at various locations in the facility based on the analysis of the sensor data, wherein the one or more defects is detected in real time;
creating, at the defect diagnostic engine with the processor, a planned maintenance chart, wherein the planned maintenance chart is based on the detection of the one or more defects and the analysis of the sensor data by using the machine learning algorithms,
wherein the defect diagnostic engine comprising a financial analyser and a longevity estimator, a probability of failure predictor, or both; and
sending, at the defect diagnostic engine with the processor, the planned maintenance chart to a user with facilitation of a plurality of media devices, wherein the planned maintenance chart is sent to the user in real time.

2. The computer-implemented method as recited in claim 1, wherein the one or more sensors comprising a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

3. The computer-implemented method as recited in claim 1, wherein the plurality of equipment comprising distribution board, transformer, electricity meter, escalators, heating unit, ventilation unit, boiler unit, direct generation system, transmission system, air conditioning unit, fire detection system, circuit breaker, elevators, electricity meter, circuit disconnects, junction boxes, and electric switchgear.

4. The computer-implemented method as recited in claim 1, wherein the sensor data comprising device temperature, facility temperature, usage time of device, device behavior, device output, device efficiency, device anomaly history, lighting settings, air pressure data, humidity, and air quality index.

5. The computer-implemented method as recited in claim 1, wherein the plurality of media devices comprising a computer, laptop, smart television, PDA, electronic tablet, smartphone, wearable devices, tablet, smartwatch, smart display, and gesture-controlled devices.

6. The computer-implemented method as recited in claim 1, further comprising obtaining, at an alert module associated with the defect diagnostic engine, the planned maintenance chart from the defect diagnostic engine, wherein the planned maintenance chart is obtained in real time.

7. The computer-implemented method as recited in claim 1, further comprising sending, at the alert module, a maintenance alert to the user on the plurality of media devices, wherein the maintenance alert is sent based on the planned maintenance chart for each of the one or more sensors receiving faults on a periodic basis.

8. The computer-implemented method as recited in claim 1, wherein the one or more faults comprising short circuit fault, device failure, symmetrical fault, unsymmetrical fault, temperature fault, efficiency fault, device noise fault, circuit overload, and lighting fault.

9. The computer-implemented method as recited in claim 1, further comprising identifying, at the defect diagnostic engine, facility location, fault location, anomaly type, mean time to repair, required device and required skills, wherein the identification is done in real time.

10. A computer system comprising:
one or more processors; and
a memory coupled to the one or more processors, the memory for storing instructions which, when executed by the one or more processors, cause the one or more processors to perform a method for predicting a maintenance time of a plurality of equipment used in a facility, the method comprising:
receiving, at a facility management system, a sensor data from one or more sensors, wherein the one or more sensors is installed at the plurality of equipment, wherein the plurality of equipment is installed at various locations in the facility, wherein the sensor data is received in real time;
collecting, at a cloud platform associated with the facility management system, the sensor data, wherein the cloud platform is associated with a server, wherein the sensor data is collected in real time;
analysing, at a defect diagnostic engine associated with the facility management system, the sensor data for detection of one or more defects in the one or more sensors installed at the plurality of equipment by using machine learning algorithms, wherein the sensor data is analysed in real time;
detecting, at the defect diagnostic engine, the one or more defects in the one or more sensors and the plurality of equipment installed at various locations in the facility based on the analysis of the sensor data, wherein the one or more defect is detected in real time;
creating, at the defect diagnostic engine, a planned maintenance chart, wherein the planned maintenance chart is based on detection of the one or more defects and the analysis of the sensor data by using machine learning algorithms,
wherein the defect diagnostic engine comprising a financial analyser and a longevity estimator, a probability of failure predictor, or both; and
sending, at the defect diagnostic engine, the planned maintenance chart to a user with facilitation of a plurality of media devices, wherein the planned maintenance chart is sent to the user in real time.

11. The computer system as recited in claim 10, wherein the one or more sensors comprising a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

12. The computer system as recited in claim 10, wherein the plurality of equipment comprising distribution board, transformer, electricity meter, escalators, heating unit, ventilation unit, boiler unit, direct generation system, transmission system, air conditioning unit, fire detection system, circuit breaker, elevators, electricity meter, circuit disconnects, junction boxes, and electric switchgear.

13. The computer system as recited in claim 10, wherein the sensor data comprising device temperature, facility temperature, usage time of device, device behavior, device output, device efficiency, device anomaly history, lighting settings, air pressure data, humidity, and air quality index.

14. The computer system as recited in claim 10, wherein the plurality of media devices comprising a computer, laptop, smart television, PDA, electronic tablet, smartphone, wearable devices, tablet, smartwatch, smart display, and gesture-controlled devices.

15. The computer system as recited in claim 10, further comprising obtaining, at an alert module associated with the defect diagnostic engine, the planned maintenance chart from the defect diagnostic engine, wherein the planned maintenance chart is obtained in real time.

16. The computer system as recited in claim 10, further comprising sending, at the alert module, a maintenance alert to the user on the plurality of media devices, wherein the maintenance alert is based on the planned maintenance chart for each of the one or more sensors receiving faults on a periodic basis.

17. The computer system as recited in claim 10, wherein the one or more faults comprising short circuit fault, device failure, symmetrical fault, unsymmetrical fault, temperature fault, efficiency fault, device noise fault, circuit overload, and lighting fault.

18. A non-transitory computer-readable storage medium encoding computer executable instructions that, when executed by at least one processor, performs a method for predicting a maintenance time of a plurality of equipment used in a facility, the method comprising:
receiving, at a computing device, a sensor data from one or more sensors, wherein the one or more sensors is installed at the plurality of equipment, wherein the plurality of equipment is installed at various locations in the facility, wherein the sensor data is received in real time;
collecting, at a cloud platform associated with the computing device, the sensor data, wherein the cloud platform is associated with a server, wherein the sensor data is collected in real time;
analysing, at a defect diagnostic engine associated with the computing device, the sensor data for detection of one or more defects in the one or more sensors installed at the plurality of equipment by using machine learning algorithms, wherein the sensor data is analysed in real time;
detecting, at the computing device, the one or more defects in the one or more sensors and the plurality of equipment installed at various locations in the facility based on the analysis of the sensor data, wherein the one or more defect is detected in real time;
creating, at the computing device, a planned maintenance chart, wherein the planned maintenance chart is based on detection of the one or more defects and the analysis of the sensor data by using machine learning algorithms,
wherein the defect diagnostic engine comprising a financial analyser and a longevity estimator, a probability of failure predictor, or both; and
sending, at the computing device, the planned maintenance chart to a user with facilitation of a plurality of media devices, wherein the planned maintenance chart is sent to the user in real time.

19. The non-transitory computer-readable storage medium as recited in claim 18, wherein the one or more sensors comprising a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

20. The non-transitory computer-readable storage medium as recited in claim 18, wherein the plurality of equipment comprising distribution board, transformer, electricity meter, escalators, heating unit, ventilation unit, boiler unit, direct generation system, transmission system, air conditioning unit, fire detection system, circuit breaker, elevators, electricity meter, circuit disconnects, junction boxes, and electric switchgear.
